(19) United States
(12) Patent Application Publication
(10) Pub. No.: US 2026/0197753 A1
(43) Pub. Date: Jul. 9, 2026

(54) COLLECTING AND EXPOSING NETWORK ENERGY RELATED INFORMATION IN A COMMUNICATION SYSTEM

(71) Applicant: RAKUTEN MOBILE, INC., Tokyo (JP)

(72) Inventors: Manmeet Singh BHANGU, Indore, Madhya Pradesh (IN); Kenichiro AOYAGI, Tokyo (JP)

(73) Assignee: RAKUTEN MOBILE, INC., Tokyo (JP)

(21) Appl. No.: 18/839,814

(22) PCT Filed: May 29, 2024
(86) PCT No.: PCT/IN2024/050633

§ 371 Date: Aug. 20, 2024

(30) Foreign Application Priority Data
Sep. 29, 2023 (IN) 202341065491
Nov. 2, 2023 (IN) 202341074832

(51) Int. Cl. H04W 52/02; H04L 43/08

(52) U.S. Cl. CPC H04W 52/0206; H04L 43/08

(57) ABSTRACT

The present disclosure discloses techniques for collecting and exposing network energy related information in a communication system. In one embodiment, the present disclosure discloses a method which comprises receiving, from an application function, a request for network energy related information associated with at least one network element. The received request comprises information identifying the at least one network element. The method further comprises based at least on the information identifying the at least one network element, obtaining, from an Operations, Administration and Maintenance node, the network energy related information associated with the at least one network element. The method further comprises transmitting the obtained network energy related information associated with the at least one network element to the application function.

### CROSS-REFERENCE TO RELATED APPLICATIONS

This application claims priority to Indian provisional patent application 202341065491 filed on Sep. 29, 2023 and Indian provisional patent application 202341074832 filed on Nov. 2, 2023, the entire contents of which are incorporated herein by reference.

### FIELD

The present disclosure relates to collecting and exposing network energy-related information in a communication system.

### BACKGROUND

The information disclosed in this background section is only for enhancement of understanding of the general background of the disclosure and should not be taken as an acknowledgement or any form of suggestion that this information forms the prior art already known to a person skilled in the art.

Mobile telecommunications industry is experiencing tremendous growth in recent decades, driven by ever-increasing demand for connectivity and data services. To cater the ever-increasing demand of connectivity and data services, the technology is being constantly advanced and the advances in the technology have resulted in rapid growth in the field of wireless communication technology. The latest advancement in wireless communication technology is the development of next generation wireless communication systems (e.g., 5^{th} Generation or 5G wireless systems). The 5G wireless systems aim to provide high reliability and throughput, lower latency, and support for a large number of devices compared to earlier wireless systems (e.g., 4G or 3G). The 5G wireless systems also aim at improved support of machine-to-machine communication (i.e., Internet of things) at lower cost and lower network energy consumption compared to the earlier wireless systems.

In a typical 5G wireless system, a base station and a user equipment (UE) interact with each other for communication services. The UE may connect to a 5G network using a 5G Radio Access Network (RAN) and a 5G Core Network (CN). The next generation wireless communication systems (e.g., 5G wireless systems) are expected to accommodate more demanding services, e.g., Extended Reality (XR), Artificial Intelligence (AI), Machine Learning (ML), etc. which may require higher energy consumption at device side (e.g., at UE side) as well as the network side (e.g., CN side). The impact on network and device side to support these services may be huge and sometimes unpredictable. For instance, when an operator A is deploying a communication service to meet application service requirements (e.g., a gaming application requirements), a customer (e.g., a service provider) needs to make sure that the application service does not consume significant energy for the end users (i.e., device side) as well as for the network side. Any potential high energy consumption or inefficient energy usage by the application service might prompt adjustments at the application layer within the service provider's domain to address these concerns.

Further, the advent of next generation technologies (e.g., 5G technology) and the widespread use of mobile devices is resulting in a substantial rise in energy consumption (also referred to as “energy usage”) in the telecommunications industry. The surge in energy usage has raised significant environmental concerns, primarily related to greenhouse gas emissions and the depletion of finite energy resources. Thus, many mobile network operators (MNOs) are setting up targets to reduce greenhouse gas emissions in coming years with an ultimate goal of achieving net-zero emissions. Though 5G wireless system offers improved energy-efficiency, new 5G use cases and the wider adoption of 5G wireless system may result in an increased number of sites and antennas resulting increase in carbon emissions. To cut down the emissions and increase/enhance network efficiency, MNOs are transitioning towards more sustainable practices by showing interests in powering their network using renewable energy sources.

However, in order to address the energy related issues for the wireless communications system and to enhance network energy-saving strategies, there is a need to understand different energy states within the network systems. Specifically, it becomes important for the MNOs to collect and monitor different types of energy consumption related information associated with the network, sources of the different types of energy consumption related information (i.e., renewable or non-renewal energy sources), and make the energy consumption related information available to customers and authorized third parties. Said differently, it becomes important for the MNOs to collect, monitor, and expose different types of energy consumption related information associated with the network (e.g., renewal energy consumption information, total energy consumption information, and energy efficiency information).

### SUMMARY

To address the above-mentioned and other related problems, the present disclosure discloses techniques for collecting and exposing different types of network energy consumption related information (e.g., renewal energy consumption information, total energy consumption information, and energy efficiency information). Specifically, the present disclosure proposes a solution for ‘network energy related information exposure’, for ‘renewable energy consumption information exposure’ and for ‘application energy efficiency monitoring’ for different use cases as discussed in the 3GPP specification TR 22.882V19.1.0.

In one non-limiting embodiment, the present disclosure discloses a method which comprises receiving, from an application function, a request for network energy related information associated with at least one network element. The received request comprises information identifying the at least one network element. The method further comprises based at least on the information identifying the at least one network element, obtaining, from an Operations, Administration and Maintenance node, the network energy related information associated with the at least one network element. The method further comprises transmitting the obtained network energy related information associated with the at least one network element to the application function.

In one non-limiting embodiment, the present disclosure discloses an apparatus which is configured to receive, from an application function, a request for network energy related information associated with at least one network element. The request comprises information identifying the at least one network element. The apparatus is further configured to based at least on the information identifying the at least one network element, obtain, from an Operations, Administration and Maintenance node, the network energy related information associated with the at least one network element. The apparatus is further configured to transmit the obtained network energy related information associated with the at least one network element to the application function.

In one non-limiting embodiment, the present disclosure discloses a non-transitory computer readable media storing one or more computer executable instructions which, when executed by an apparatus, cause the apparatus to receive, from an application function, a request for network energy related information associated with at least one network element. The request comprises information identifying the at least one network element. The one or more instructions further cause the apparatus to based at least on the information identifying the at least one network element, obtain, from an Operations, Administration and Maintenance node, the network energy related information associated with the at least one network element. The one or more instructions further cause the apparatus to transmit the obtained network energy related information associated with the at least one network element to the application function.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a high-level block diagram of an example communication system 100 for collecting and exposing network energy related information, in accordance with some embodiments of the present disclosure.

FIG. 2 illustrates an example procedural flow 200 for data collection from an OAM node 110, in accordance with some embodiments of the present disclosure.

FIG. 3 illustrates an example procedural flow 300 for exposing renewal energy consumption information, in accordance with some embodiments of the present disclosure.

FIG. 4 illustrates an example procedural flow 400 for exposing energy efficiency information, in accordance with some embodiments of the present disclosure.

FIG. 5 illustrates a block diagram of an apparatus 500, in accordance with some embodiments of the present disclosure.

FIG. 6 shows a flowchart illustrating an example method 600 for collecting and exposing network energy related information in the communication system 100, in accordance with some embodiments of the present disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In the present disclosure, the terms like “communication system”, “system”, and “wireless communication system” have been used interchangeably throughout the specification.

As discussed in the background section, to cut down the emissions and increase/enhance network efficiency, MNOs are transitioning towards more sustainable practices to address environmental impacts by showing interests in powering their network using renewable energy sources. In response to the growing awareness of environmental challenges, the MNOs are increasingly recognizing their role in mitigating the negative effects of their operations. One crucial aspect of these efforts is collection and exposure of the network energy related information or data (e.g., network energy consumption information, renewable energy information, and energy efficiency information). In some network deployments, the measurements of the network energy related information of a network function or a group of network functions may be carried in an Operations, Administration, and Management (OAM) node. To support energy consumption and efficiency as a service criterion, this information needs to be accessible by the core network e.g., to perform creation of subscription policies and subsequently policy control. Thus, there is a need to assess how the core network can efficiently collect and expose/share the network energy related information within the current subscription and policy control framework to enhance network energy-saving strategies.

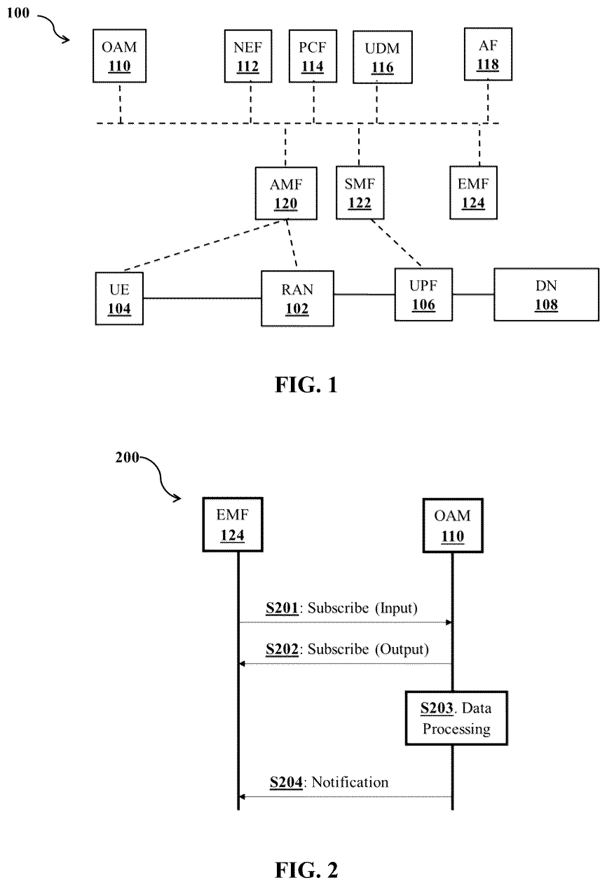

FIG. 1 illustrates a high-level block diagram of an example communication system (or a 5G system architecture) 100 for collecting and exposing network energy related information, in accordance with some embodiments of the present disclosure. The communication system 100 may comprise a core network (CN), at least one User Equipment (UE) 104, and a Radio Access Network (RAN) 102. The CN orchestrates the various network functions and services. The CN employs virtualized network functions (VNFs) and software-defined networking (SDN) principles to provide flexible and scalable connectivity services. The CN manages functions such as session management, mobility management, and service provisioning.

The at least one UE 104 may be communicatively coupled with the RAN 102. The at least one UE 104 may be any mobile or non-mobile computing device including, but not limited to, a phone (e.g., a cellular phone or smart phone), a pager, a laptop computer, a desktop computer, a wireless handset, a portable communication device, a portable computing device (e.g., a personal data assistant), an entertainment device (e.g., a music or video device, or a satellite radio), a global positioning system device, or any other suitable computing device including a wired or wireless communications interface. In some embodiments of the present disclosure, the at least one UE 104 may be Internet-of-Things (IOT)-enabled device including, but not limited to, vehicles configured to communicate with a base station or a core network.

The RAN 102 serves as a bridge between the CN and the at least one UE 104. The RAN 102 may include one or more base stations to deliver high-speed, low-latency wireless connectivity to the at least one UE 104. In the context of a fourth generation (4G) Long Term Evolution (LTE) communication system, a base station may be referred to as an “evolved NodeB” or “eNodeB,” and in the context of a fifth generation (5G) communication system, the base station may be referred to as a “gNodeB” or “gNB”. A distributed gNB can be partitioned into one or more networking applications which may include one or more central unit entities (CUs), one or more distributed unit entities (DUs), and one or more radio units (RUs). The one or more RUs may be deployed in a physical location where radio coverage is to be provided to the at least one UE 104. In the present disclosure, the term “base station” may be interchangeably used with “RAN”.

In an example embodiment, the communication system 100 shows a 5G communication system comprising a user plane and a control plane. The user plane may be configured to carry data corresponding to the users. In other words, the user plane handles actual transmission of data packets between the at least one UE 104 and different network entities. The control plane, on the other hand, is responsible for managing and controlling the communication system 100. Control plane may be configured to carry controlling traffic such as signaling traffic associated with the communication system 100. The user plane may comprise a User Plane Function (UPF) 106, which is a network function that forms a part of the 5G core network. The at least one UE 104 may connect to the UPF 106 via the RAN 102. The communication system 100 may further comprise at least one Data Network (DN) 108 which represents external networks or that interact with the core network. The DN 108 may include Internet, private networks, cloud services, or other similar communication systems.

As shown in FIG. 1, the communication system 100 may comprise at least one Operations, Administration, and Maintenance (OAM) node 110. The OAM node 110 may comprise a set of processes, protocols, and tools configured to monitor, control, troubleshoot, and optimize various aspects of the communication system 100. The various aspects may include operations, administration, and maintenance tasks. The operations tasks may comprise network functioning related tasks such as network performance monitoring, configuration management, and fault detection. The administration tasks include user management, access control, policy enforcement, and resource allocation. The maintenance tasks include software upgrades, hardware replacements, and capacity planning to accommodate growing demand. It may be noted that the arrangement of components shown in FIG. 1 is purely for illustrative purposes. Typically, the OAM node 110 is situated outside 5G Core (5GC) and interacts with various network functions of the 5GC, the RAN 102, etc.

The communication system 100 (and specifically, the control plane of the core network) may further comprise various network functions such as: one or more instances of a Network Exposure Function (NEF) 112, a Policy Control Function (PCF) 114, a Unified Data Management (UDM) 116, an Application Function (AF) 118, an Access and Mobility Management Function (AMF) 120, a Session Management Function (SMF) 122, and an Energy Management Function (EMF) 124. However, the present disclosure is not limited thereto and it may be noted that the CN may additionally comprise other network functions such as at least one Network Repository Function (NRF), at least one Authentication Server Function (AUSF), at least one Network Slice Selection Function (NSSF), but not limited thereto.

The NEF 112 enables exposure of network capabilities to external applications and acts as an interface that allows authorized third-party applications or services to access network data and functionalities. The PCF 114 is responsible for enforcing policy decisions related to quality of service (QOS), access control, network resource allocation, but not limited thereto. The UDM 116 function in a 5G network acts as a centralized repository for subscriber-related data and profiles. Specifically, the UDM 116 stores subscriber authentication credentials, subscription information, and other user-related data.

The AF facilitates integration of specialized applications or services directly into the communication system 100. The AMF 120 is responsible for managing access to a network and handling mobility-related functions for the at least UE 104. The SMF 122 is responsible for establishing, managing, and terminating data sessions between the UE 104 and different network services. Typically, the SMF 122 handles session establishment, session continuity management, and session termination. The UPF 106 is responsible for various data processing tasks including packet routing, forwarding, traffic optimization, but not limited thereto.

The core network is typically based on service-based architecture which is a system architecture in which system functionalities are achieved by a set of Network Functions (NFs) providing services to other authorized NFs to access their services. In such architecture, the various network entities of the communication system 100 may be connected together or the interactions between the network entities may be represented in two ways: point to point links (referred to as “Reference points” or reference point representation) or with Service Based Interfaces (SBIs) (or service-based representation). The NFs in 5GC use the SBIs for interactions while the interactions outside 5GC use other protocols such as Next-Generation Application Protocol (NGAP), Packet Forwarding Control Protocol (PFCP), etc. The reference points may comprise N1 (reference point between the UE 104 and the AMF 120), N2 (a reference point between the RAN 102 and the AMF 120), N3 (a reference point between the RAN 102 and the UPF 106), N4 (a reference point between the SMF 122 and the UPF 106), N6 (a reference point between the UPF 106 and the DN 108), and N9 (a reference point between two UPFs 106). A SBI represents a set of services provided or exposed by a particular NF. This is the interface where the NF service operations are invoked. The SBIs exhibited by the various NFs within the 5G core network may comprise Namf, Nsmf, Nudm, Nnrf, Nnssf, Nausf, Nnef, Npcf, Naf, Nemf, but not limited thereto.

As discussed earlier, in some network deployments, measurements of network energy related information are carried out in the OAM node 110. To support energy consumption and efficiency as a service criterion, network energy related information needs to be accessible by the 5G Core (5GC). Once the information is stored in the 5GC, the information may be exposed to one or more authorized 3^{rd} parties (e.g., the AF 118).

In some embodiments of the present disclosure, the network energy related information in 5GC may be managed by the EMF 124 which may be a new network function. Alternatively, or additionally, in some non-limiting embodiments, some or all functionalities of the EMF 124 may be implemented in an existing 5GC network function (e.g., the NEF, the PCF 114, but not limited thereto). In one non-limiting embodiment, the EMF 124 may obtain ratio of renewable energy (of at least one network element) from the OAM node 110. The network function EMF may also be referred to as “Energy Efficiency Control Function”, “Energy Management and Efficiency Control Function”, “EECF”, “EMECF”.

The forthcoming paragraphs describe high-level procedures and information flows in accordance some embodiments of the present disclosure.

FIG. 2 illustrates an example procedural flow 200 for data collection from the OAM node 110, in accordance with some embodiments of the present disclosure. Specifically, FIG. 2 illustrates interactions between the EMF 124 and the OAM node 110 for data collection, in accordance with some embodiments of the present disclosure. Here, the data collection refers to collecting or obtaining the network energy related information associated with at least one network element from the OAM node 110. The at least one network element may comprise any logical or physical network entity such as a network slice, a network function, a UE, a PDU Session, a QoS flow, but no limited thereto. In one non-limiting embodiment, Management Data Analytics (MDA) services related to renewable energy consumption may be defined and the EMF 124 may subscribe to them.

Typically, the EMF 124 may be configured on how to subscribe to relevant OAM services. In step S201 [i.e., subscribe (Input)], the EMF 124 may be configured to subscribe to notification(s) related to the services provided by the OAM node 110. Specifically, the EMF 124 may transmit a subscription request to the OAM node 110, requesting the OAM node 110 to notify regarding availability of the network energy related information associated with at least one network element. The subscription request may comprise information identifying the at least one network element for which the EMF 124 requests the network energy related information. Additionally, the subscription request may comprise one or more parameters such as consumer reference, time tick, and filter. The consumer reference indicates an address of the EMF 124 at which the notification is to be sent. The time tick indicates an initial value of a timer held by the OAM node 110. This value defines a time window within which the EMF 124 intends to invoke the “subscribe” operation again to confirm its subscription. The filter constraint that the OAM node 110 uses to filter notifications.

In one non-limiting embodiment, the subscription request may comprise a type of the requested network energy related information associated with the at least one network element. For instance, the EMF 124 may specify a type of the energy related information being requested. The type of the requested network energy related information may comprise one or more of renewal energy consumption information associated with the at least one network element, total energy consumption information associated with the at least one network element, and energy efficiency information associated with the at least one network element.

In step S202 (i.e., [Subscribe (Output)], the OAM node 110 responds to the EMF 124 whether the subscription is successful or not. Specifically, in response to transmitting the subscription request, the EMF 124 receives a subscription response from the OAM node 110 indicating whether the requested subscription (for notifying regarding the availability of the network energy related information) is successful or unsuccessful. The subscription response may comprise one or more parameters such as subscription ID and status. The subscription ID comprises an unambiguous identity of the subscription and the status may comprise one of Operation_Succeeded (e.g., when the subscription is successfully created), Operation_Failed_Existing_Subscription (e.g., when subscription is not created because it is duplicated or conflict with existing subscription(s)), and Operation_Failed (e.g., when the operation is failed for any other reason than being duplicated or conflict with existing subscription(s)).

In one non-limiting embodiment, when the EMF 124 specifies the type of the network energy related information being requested, the OAM node 110 may create subscription only for the specified network energy related information type. In one non-limiting embodiment, when the subscription request does not comprise a type of the requested network energy related information, the OAM node 110 may create subscription of all possible types of the energy related information i.e., renewal energy consumption information, total energy consumption information, and energy efficiency information.

In step S203 [i.e., data processing], the OAM node 110 prepares data file related to the network energy related information associated with the at least one network element. Specifically, the OAM node 110 may calculate the network energy related information for the at least one network element (depending on the type of the network energy related information being requested). For example, in case of the at least one network element is composed of Virtualized Network Functions (VNF) running on a Network Function Virtualization Infrastructure (NFVI), it is expected to be able to measure the energy consumption of each VNF separately. In another example, energy consumption of a network element (running as a NF) may be now estimated as follows:
The energy consumed by the network element is the sum of the energy consumed by all its constituent VNF/Virtualized Network Function Component (VNFC) instances.
For each VNF/VNFC instance, its estimated energy consumption is a proportion of the NFVI node energy consumption on which the VNF/VNFC instance runs.
This proportion is equal to the vCPU mean usage of the VNF/VNFC instance relatively to a sum of the vCPU mean usage of all VNF/VNFC instances running on the same NFVI node.

In step S204 [i.e., Notification (notifyFileReady)], the OAM node 110 notifies the EMF 124 that the data file is ready. In other words, the EMF 124 may receive a notification indicating the availability of the network energy related information associated with the at least one network element (depending on the type of the network energy related information being requested). Upon receiving such notification, the EMF 124 may fetch or obtain the network energy related information from the OAM node 110 using at least one of a streaming method and a File Transfer Protocol (FTP). The file transfer protocols may comprise at least one of Secure shell file transfer protocol (SFTP), File Transfer Protocol over Explicit TLS/SSL (FTPES), and Hypertext Transfer Protocol Secure (HTTPS). It may be noted that the OAM node 110 acts as a server while the EMF 124 acts as a client of the file transfer actions.

It may be noted that for the sake of simplicity, the call flow in FIG. 2 only shows a subscribe-notify model. However, the present disclosure is not limited thereto and in general, both request-response and subscription-notification models can be used for collecting data from the OAM node 110.

In one example, at least one network element may comprise a network slice for which the network energy related information is requested, where the network slice is virtual network instances tailored to specific service requirements, allowing segmentation and customization of network for different use cases. In such an example, the information identifying the at least one network element may comprise Single-Network Slice Selection Assistance Information (S-NSSAI) associated with the network slice. Further, it may be noted that the EMF 124 is configured with Network Slice information (i.e., NetworkSliceInfo including a Distinguished Name (DN) of the NetworkSlice managed object relating to a network slice instance associated to the S-NSSAI and Network Slice Instance Identifier (NSI ID), if available). Based on the Network Slice information, the EMF 124 may use the DN to identify the NetworkSlice managed object relating to the S-NSSAI and NSI ID and may consume management services to collect the management data (or the network energy related information) of the corresponding NetworkSlice managed object.

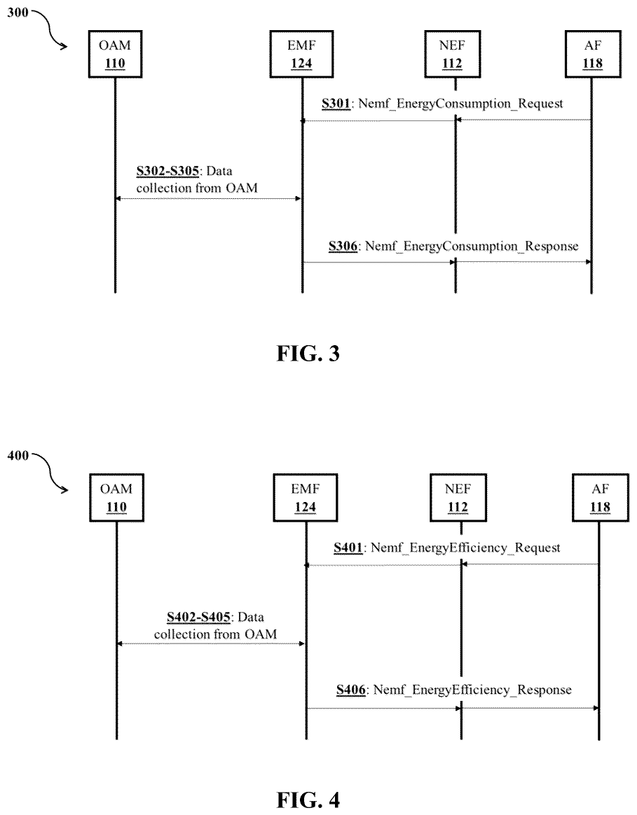

In this manner, the EMF 124 collects network energy related information from the OAM node 110. FIGS. 3-4 illustrate example procedural flows for exposing the collected network energy related information, in accordance with some embodiments of the present disclosure.

FIG. 3 illustrates an example procedural flow 300 for exposing renewal energy consumption information, in accordance with some embodiments of the present disclosure.

In Step 301, the AF 118 may transmit a request (e.g., Nemf_EnergyConsumption_Request) to the EMF 124 for renewal energy consumption information associated with at least one network element. And the EMF 124 may receive, from the AF 118, the request for the renewal energy consumption information associated with the at least one network element. In some embodiments, the request may comprise identification information identifying the at least one network element for which the renewal energy consumption information is being requested. The at least one network element may comprise any logical or physical network entity such as a network slice, a network function, a UE, a PDU Session, a QoS flow, but no limited thereto.

In Steps S302-S305, the EMF 124 may fetch or obtain the renewal energy consumption information associated with the at least one network element from the OAM node 110. Specifically, the EMF 124 may transmit a subscription request to the OAM node 110, requesting the OAM node 110 to notify regarding availability of the renewal energy consumption information associated with at least one network element. The subscription request may comprise information identifying the at least one network element for which the EMF 124 requests the renewal energy consumption information. The EMF 124 and the OAM node 110 may follow the sequence of steps S201-S204 of FIG. 2 to fetch the renewal energy consumption information from the OAM node 110. It may be noted that the steps S302-S305 of FIG. 3 correspond to steps S201-S204 of FIG. 2 and the same are not repeated here for the sake of brevity.

In Step 306, the EMF 124 may transmit a response (e.g., Nemf_EnergyConsumption_Response) to the AF 118. The response may comprise obtained renewal energy consumption information associated with the at least one network element and the AF 118 may receive, from the EMF 124, the renewal energy consumption information associated with the at least one network element.

In one non-limiting embodiment, at least one network element may comprise a network slice for which the renewal energy consumption information is requested. In such an embodiment, the information identifying the at least one network element may comprise Single-Network Slice Selection Assistance Information (S-NSSAI) associated with the network slice. In such embodiment, the EMF 124 may transmit the subscription request to the OAM node 110, requesting the OAM node 110 to notify regarding availability of the renewal energy consumption information associated with network slice. The EMF 124 may include the S-NSSAI associated with the network slice in the subscription request and may obtain, from the OAM node 110, the renewal energy consumption information associated with the network slice identified by the S-NSSAI and transmit the obtained renewal energy consumption information associated with the network slice to the AF 118.

In one non-limiting embodiment, the AF 118 may request renewable energy consumption information for one or more individual network functions (NFs) associated with the network slice identified by S-NSSAI. In such embodiment, the EMF 124 may transmit the subscription request to the OAM node 110, requesting the OAM node 110 to notify regarding availability of the renewal energy consumption information for one or more individual NFs associated with the network slice. The EMF 124 may include identification information of the individual NFs associated with the network slice along with the S-NSSAI in the subscription request and may obtain, from the OAM node 110, the renewal energy consumption information associated with the one or more individual NFs and transmit the obtained renewal energy consumption information associated with the one or more individual NFs to the AF 118.

In one non-limiting embodiment, the request from the AF 118 may further comprise a periodicity of transmitting the renewal energy consumption information associated with the at least one network element to the AF 118 i.e., the time duration after which the EMF 124 may transmit the renewal energy consumption information to the AF 118. The time period may be daily, weekly, monthly, quarterly, yearly, but not limited thereto. In this embodiment, the EMF 124 may periodically obtain, from the OAM node 110, the renewal energy consumption information associated with the at least one network element and transmit the same to the AF 118.

In one non-limiting embodiment, the request from the AF 118 may further comprise a time duration (e.g., last week, last month, last 6 months, but not limited thereto) of which the requested renewal energy consumption information is requested. In this embodiment, the EMF 124 may obtain, from the OAM node 110, the renewal energy consumption information associated with the at least one network element for the specified time duration and transmit the obtained network energy related information to the AF 118. It may be noted that if no time duration is specified in the request from the AF 118, the EMF 124 may provide current renewable energy consumption information to the AF 118.

It may be noted that the AF 118 may be a trusted AF or an untrusted AF. Generally, a trusted AF is an application or service that is considered secure and trustworthy by a network and has higher privileges and access rights within the network. The trusted AFs are typically authorized to directly access sensitive network resources and interact with secure network functions. On the other hand, an untrusted application function is an application or service that is considered less secure or may not be fully trusted by the network and therefore, has limited access rights and privileges within the network. The untrusted AFs are typically subject to more stringent security measures and restrictions to prevent unauthorized access to sensitive network resources. The NEF 112 acts as an intermediary between the AFs 118 and the network, providing a secure and standardized interface for exposing network capabilities and services to 3^{rd} party applications.

In one non-limiting embodiment, when the AF 118 is a trusted AF, the EMF 124 may directly receive the request for renewal energy consumption information from the AF 118 (as discussed in connection with Step 301) and may directly transmit the obtained renewal energy consumption information to the AF 118 (as discussed in connection with Step 306). On the other hand, when the AF 118 is an untrusted AF, the EMF 124 may receive the request for renewal energy consumption information via the NEF 112 and may transmit the obtained renewal energy consumption information to the AF 118 via the NEF 112. In other words, when the AF 118 is an untrusted AF, the AF initially transmits the request of S301 to the NEF 112 (referred to as Nnef_EnergyConsumption_Request) and the NEF 112 sends the corresponding request (referred to as Nemf_EnergyConsumption_Request) to the EMF 124. Similarly, when the AF 118 is the untrusted AF, the EMF 124 initially transmits the response of S306 to the NEF 112 (referred to as Nemf_EnergyConsumption_Response) and the NEF 112 sends the corresponding response (referred to as Nnef_EnergyConsumption_Response) to the AF 118.

It may be noted that the procedural flow 300 of FIG. 3 is described in connection with exposing renewal energy information. However, a skilled person will appreciate that the techniques of FIG. 3 are equally applicable for exposing total energy information and the repetition of the same is avoided for the sake of brevity. It has been shown in FIG. 3 that the request “Nemf_EnergyConsumption_Request” provides information related to renewable energy consumption. However, the present disclosure is not limited thereto and in one non-limiting embodiment, the request “Nemf_EnergyConsumption_Request” may provide information related to total energy consumption and/or renewable energy consumption. When making the request, the AF 118 may indicate a type of requested energy information (i.e., whether the AF 118 is interested in obtaining total energy consumption information or specifically renewable energy consumption information).

FIG. 4 illustrates an example procedural flow 400 for exposing energy efficiency information, in accordance with some embodiments of the present disclosure. It may be noted that the techniques of FIG. 4 are essentially same as that of FIG. 3 and hence the techniques discussed in connection with FIG. 3 are equally applicable for FIG. 4.

In Step 401, the AF 118 may transmit a request (e.g., Nemf_EnergyEfficiency_Request) to the EMF 124 for energy efficiency information associated with at least one network element or the EMF 124 may receive, from the AF 118, the request for the energy efficiency information associated with the at least one network element. In some embodiments, the request may comprise identification information identifying the at least one network element for which the energy efficiency information is being requested. The at least one network element may comprise any logical or physical network entity such as a network slice, a network function, a UE, a PDU Session, a QoS flow, but no limited thereto.

In Steps S402-S405 (which correspond to steps S201-S204 of FIG. 2), the EMF 124 may fetch or obtain the energy efficiency information associated with the at least one network element from the OAM node 110. The EMF 124 and the OAM node 110 may follow the sequence of steps S201-S204 of FIG. 2 to fetch the renewal energy consumption information from the OAM node 110.

In Step 406, the EMF 124 may transmit a response (e.g., Nemf_EnergyEfficiency_Response) to the AF 118. The response may comprise obtained energy efficiency information associated with the at least one network element.

In one non-limiting embodiment, at least one network element may comprise a network slice for which the energy efficiency information is requested. In such an embodiment, the information identifying the at least one network element may comprise S-NSSAI associated with the network slice. In such embodiment, the EMF 124 may include the S-NSSAI associated with the network slice in the subscription request (of step S201) and may obtain, from the OAM node 110, the renewal energy consumption information associated with the network slice identified by the S-NSSAI and transmit the same to the AF 118.

In one non-limiting embodiment, the AF 118 may request energy efficiency information for one or more individual NFs associated with the network slice identified by S-NSSAI. In such embodiment, the EMF 124 may include identification information of the individual NFs associated with the network slice along with the S-NSSAI in the subscription request (of step S201) and may obtain, from the OAM node 110, the energy efficiency information associated with the one or more individual NFs and transmit the same to the AF 118.

In one non-limiting embodiment, the request from the AF 118 may further comprise a periodicity of transmitting the energy efficiency information to the AF 118 and the EMF 124 may periodically obtain, from the OAM node 110, the renewal energy consumption information associated with the at least one network element and transmit the same to the AF 118.

In one non-limiting embodiment, the request from the AF 118 may further comprise a time duration (e.g., last week, last month, last 6 months, but not limited thereto) of which the energy efficiency information is requested. In this embodiment, the EMF 124 may obtain, from the OAM node 110, the energy efficiency information associated with the at least one network element for the specified time duration and transmit the same to the AF 118. It may be noted that if no time duration is specified in the request from the AF 118, the EMF 124 may provide current energy efficiency information to the AF 118.

In one non-limiting embodiment, when the AF 118 is a trusted AF, the EMF 124 may directly receive the request for energy efficiency information from the AF and may directly transmit the obtained energy efficiency information to the AF 118. On the other hand, when the AF 118 is an untrusted AF, the AF 118 initially transmits the request (in step 4301) to the NEF 112 (referred to as Nnef_EnergyEfficiency_Request) and the NEF 112 sends the corresponding request (referred to as Nemf_EnergyEfficiency_Request) towards the EMF 124. Similarly, when the AF 118 is the untrusted AF, the EMF 124 initially transmits the response (in step S406) to the NEF 112 (referred to as Nemf_EnergyEfficiency_Response) and the NEF 112 sends the corresponding response (referred to as Nnef_EnergyEfficiency_Response) to the AF 118.

It may be noted that for the sake of simplicity, the procedural flows of FIGS. 3-4 only show request-response models. However, the present disclosure is not limited thereto and in general, both request-response and subscription-notification models can be used for exposing network energy related information.

In one non-limiting embodiment, a single procedural flow may be used for exposing information related to the renewal energy consumption information, the total energy consumption information, and the energy efficiency information. In such embodiment, the request of Step S301 or S401 may comprise information indicating a type of the network energy related information being requested, where the type of the network energy related information comprises one or more of renewal energy consumption information associated with the at least one network element, total energy consumption information associated with the at least one network element, and energy efficiency information associated with the at least one network element.

It may be noted that the granularity of network energy related information exposure may vary based on different situations. And energy consumption information of any network element may be acquired based on means of averaging or applying a statistical model for the energy consumed by application sessions or network functions associated with the network element.

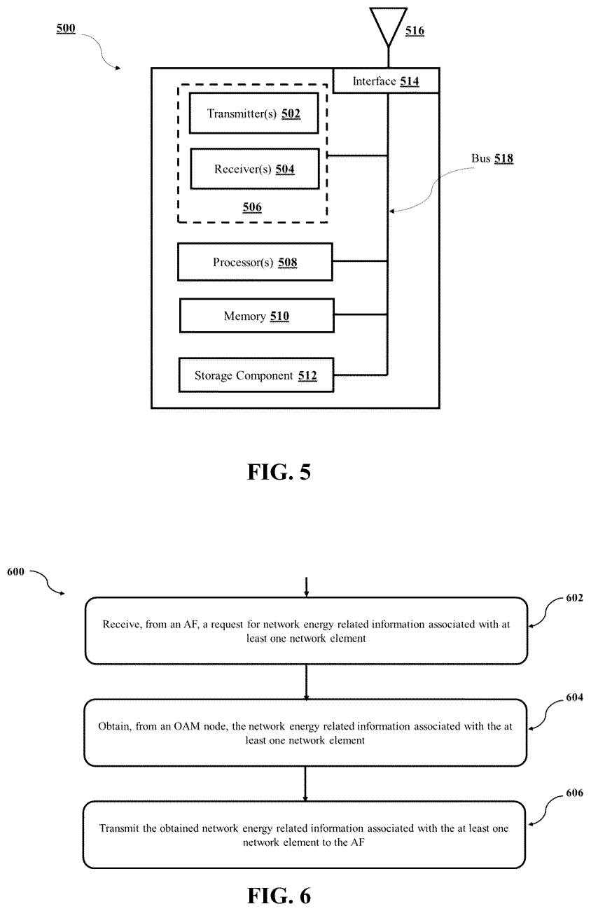

FIG. 5 illustrates a block diagram of an apparatus 500, in accordance with some embodiments of the present disclosure. As shown in FIG. 5, the apparatus 500 may comprise at least one transmitter or output component 502, at least one receiver or input component 504, at least one processor 508, at least one memory 510, at least one storage component 512, at least one interface 514, and at least one antenna 516. The at least one transmitter 502 may be configured to transmit data/information to one or more external nodes/devices using the antenna 516 and the at least one receiver 504 may be configured to receive data/information from the one or more external nodes/devices using the antenna 516. The at least one transmitter and receiver may be collectively implemented as a single transceiver or input-output module 506. In one non-limiting embodiment, the at least one processor 508 may be communicatively coupled with the transceiver 506, memory 510, storage component 512, interface 514, and antenna 516 (e.g., via a bus 518) for implementing the techniques consistent with the present disclosure. The bus 518 may include a wired interconnection or a wireless interconnection.

The at least one processor 508, as used herein, means any type of computational circuit that may comprise hardware elements and software elements. The processor 508 may be embodied as a multi-core processor, a single core processor, or a combination of one or more multi-core processors and/or one or more single core processors, a distributed processing system, or the like. The processor 508 may be a Central Processing Unit (CPU), a graphics processing unit (GPU), an accelerated processing unit (APU), an application-specific integrated circuit (ASIC), or another type of processing component.

The memory 510 may include a non-transitory computer readable medium. The memory 510 may include a random-access memory (RAM), a read only memory (ROM), and/or another type of dynamic or static storage device (e.g., a flash memory, a magnetic memory, and/or an optical memory) that stores information and/or instructions for use by processor 508. The memory 510 may comprise machine-readable instructions which are executable by the processor 508. These machine-readable instructions when executed by the processor 508 cause the processor 508 to perform one or more method steps of an embodiment described above.

The apparatus 500 may include a storage component 512 which stores information and/or software related to the operation and use of the apparatus 500. For example, the storage component 512 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The communication interface 514 is an interface that provides a communication connection to other devices, such as external devices and internal devices. The connection by the communication interface 514 can be a wired connection, a wireless connection, or a combination of wired and wireless connections, and can be a direct connection or an indirect connection via a communication network that exists between the apparatus 500 and other devices. In other words, the standard of the communication interface 514 is not limited.

The bus 518 acts as an interconnect between the processor 508, the memory 510, the storage component 512, the transmitter 502, the receiver 504, the communication interface 514, and the antenna 516 of the apparatus 500.

The number and arrangement of components shown in FIG. 5 are provided as an example. In practice, the apparatus 500 may include additional components, fewer components, different components, or differently arranged components than those shown in FIG. 5. Additionally, or alternatively, a set of components (e.g., one or more components) of the apparatus 500 may perform one or more functions described as being performed by another set of components of the apparatus 500. Further, one or more method steps described in any of the embodiments may be performed utilizing a plurality of apparatuses 500 in communication with one another.

In one non-limiting embodiment, the apparatus 500 may be used to implement some or all functions of the UE 104, the RAN 102, the core network, but not limited thereto. Specifically, the apparatus 500 may implement the functionalities of the EMF 124 and/or any other network function or network node.

Referring now to FIG. 6, a flowchart is described illustrating an example method 600 performed by a network function for collecting and exposing network energy related information in a communication system 100, according to an embodiment of the present disclosure. The network function may be the EMF 124 and the functionalities of the network function 124 may be implemented with the help of the apparatus 500 (and particularly, with the help of the at least one processor 508).

The method 600 may include, at block 602, receiving, from an AF 118, a request for network energy related information associated with at least one network element. The request may comprise information identifying the at least one network element. For example, the apparatus 500 may be configured to receive the request for network energy related information associated with the at least one network element.

At block 604, the method 600 may include based at least on the information identifying the at least one network element, obtaining, from an OAM node 110, the network energy related information associated with the at least one network element. For example, the apparatus 500 may be configured to obtain, from the OAM node 110, the network energy related information associated with the at least one network element.

At block 606, the method 600 may include transmitting the obtained network energy related information associated with the at least one network element to the AF 118. For example, the apparatus 500 may be configured to transmit the obtained network energy related information associated with the at least one network element to the AF 118.

The present disclosure discloses techniques which describe what different types of network energy related information may be exposed and at what granularity (e.g., per network slice, per UE, per NF, per Protocol Data Unit (PDU) Session, per Quality of Service (QOS) flow, etc.) the network energy related information may be exposed. Further, the present disclosure described how the network energy related information may be exposed.

The present disclosure also discloses the feasibility of disclosing data on renewable energy sources in a communication system The present disclosure discloses about the mechanisms for disclosing data on renewable energy sources involved at various granularities in the communication system. The present disclosure focusses on the sustainable practices and transparency efforts of MNOs, exploring how they can contribute to reducing the carbon footprint and promoting renewable energy utilization within the telecommunications industry.

Thus, the present disclosure provides techniques for efficiently collecting and exposing the network energy related information to various stakeholders. Specifically, the present disclosure discloses techniques for exposing information related to network energy usage at various granularities in the network. By sharing the network energy related information, the stakeholders (e.g., customers) gain valuable insights into carbon footprint of telecommunications operations, thus providing a foundation for informed decision-making and targeted strategies to address environmental concerns.

Further, transparent reporting of energy usage and renewable energy consumption emphasizes an MNO's commitment to transparency, accountability, and sustainability. This builds trust and confidence among consumers, investors, regulators, and the wider public, as it demonstrates a seriousness to disclose and address environmental impacts. Moreover, a standard way for MNOs to share network energy related information, allows for fair comparisons between different MNOs. This creates healthy competition, where operators work hard to use energy more efficiently and switch to renewable sources. This competition doesn't just drive innovation but also encourages the industry to deploy greener technologies.

In the context of present disclosure, the term “Energy Consumption” (EC) for a network element refers to an average power/energy consumption of the network element over a specified period of time. Further, the term “Energy Efficiency” (EE) for a network element may be expressed in terms of Data Volume divided by the Energy Consumption of the network element. In the case of RAN, the EE may be expressed by the Coverage Area divided by the Energy Consumption of the network element. Hence, the EE of a network element may be defined as the ratio of a chosen performance metric (such as data volume, number of users served, coverage area, etc.) to the energy consumption of the network during a specified period of time.

The goal of defining and measuring EC and EE of the network elements is to assess and optimize energy consumption and energy efficiency of communication systems for reducing energy consumption while maintaining network performance and quality of service (QoS). Such optimization of the energy consumption and energy efficiency not only contributes to cost savings but also aligns with sustainability goals by minimizing environmental impact due to various operations of the communication systems.

In the context of present disclosure, the term “Renewable Energy” refers to energy from renewable sources or energy from renewable non-fossil sources. For example (but not limited to) wind, solar, aerothermal, geothermal, hydrothermal, but not limited thereto. Further, the term “Energy Saving” may refer to reduction of Energy Consumption deriving from some actions, compared with the Energy Consumption when the actions are not taken.

### Embodiments

Embodiment 1. A method comprising: receiving, from an application function, a request for network energy related information associated with at least one network element, wherein the request comprises information identifying the at least one network element; based at least on the information identifying the at least one network element, obtaining, from an Operations, Administration and Maintenance (OAM) node, the network energy related information associated with the at least one network element; and transmitting the obtained network energy related information associated with the at least one network element to the application function.

Embodiment 2. The method as claimed in embodiment 1, wherein obtaining the network energy related information associated with the at least one network element comprises: transmitting a subscription request to the OAM node, requesting the OAM node to notify regarding availability of the network energy related information associated with the at least one network element, wherein the subscription request comprises the information identifying the at least one network element; in response to the subscription request, receiving a subscription response from the OAM node indicating successful or unsuccessful subscription for notifying regarding the availability of the network energy related information; in response to the successful subscription, receiving a notification indicating the availability of the network energy related information associated with the at least one network element; and upon receiving the notification indicating the availability of the network energy related information, obtaining the network energy related information from the OAM node using at least one of a streaming method and a File Transfer Protocol (FTP).

Embodiment 3. The method as claimed in embodiment 1 or 2, wherein the request further comprises a type of the network energy related information being requested and a periodicity of transmitting the network energy related information to the application function, wherein the type of the requested network energy related information comprises one or more of: renewal energy consumption information associated with the at least one network element, total energy consumption information associated with the at least one network element, and energy efficiency information associated with the at least one network element.

Embodiment 4. The method as claimed in any of embodiments 1-3, wherein the at least one network element comprises a network slice for which the application function requests the network energy related information, and wherein the information identifying the at least one network element comprises Single-Network Slice Selection Assistance Information (S-NSSAI) associated with the network slice, and wherein the method comprises: obtaining, from the OAM node, network energy related information associated with the network slice identified by the S-NSSAI and transmitting the obtained network energy related information associated with the network slice to the application function.

Embodiment 5. The method as claimed in any of embodiments 1-4, wherein the request further comprises information identifying one or more network functions (NFs) associated with the network slice identified by the S-NSSAI, and wherein the method comprises: obtaining, from the OAM node, network energy related information associated with the one or more NFs and transmitting the obtained network energy related information associated with the one or more NFs to the application function.

Embodiment 6. The method as claimed in any of embodiments 1-5, wherein the request further comprises a time duration of which the network energy related information is requested, and wherein the method comprises: obtaining, from the OAM node, the network energy related information associated with the at least one network element for the time duration specified in the request and transmitting the obtained network energy related information to the application function.

Embodiment 7. The method as claimed in any of embodiments 1-6, wherein receiving the request for the network energy related information from the application function comprises: directly receiving the request for the network energy related information from the application function, when the application function is a trusted application function; and receiving the request for the network energy related information from the application function via a Network Exposure Function (NEF), when the application function is an untrusted application function.

Embodiment 8. The method as claimed in any of embodiments 1-7, wherein transmitting the obtained network energy related information associated with the at least one network element to the application function comprises: directly transmitting the obtained network energy related information associated with the at least one network element to the application function, when the application function is a trusted application function; and transmitting the obtained network energy related information associated with the at least one network element to the application function via a Network Exposure Function (NEF), when the application function is an untrusted application function.

It may be noted here that the subject matter of some or all embodiments described with reference to FIGS. 1-4 may be relevant for the method 600 and the same is not repeated for the sake of brevity. The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the appended claims.

What is claimed is:

1. A method comprising:
receiving, from an application function, a request for network energy related information associated with at least one network element, wherein the request comprises information identifying the at least one network element;
based at least on the information identifying the at least one network element, obtaining, from an Operations, Administration and Maintenance (OAM) node, the network energy related information associated with the at least one network element; and
transmitting the obtained network energy related information associated with the at least one network element to the application function.

2. The method as claimed in claim 1, wherein obtaining the network energy related information associated with the at least one network element comprises:
transmitting a subscription request to the OAM node, requesting the OAM node to notify regarding availability of the network energy related information associated with the at least one network element, wherein the subscription request comprises the information identifying the at least one network element;
in response to the subscription request, receiving a subscription response from the OAM node indicating successful or unsuccessful subscription for notifying regarding the availability of the network energy related information;
in response to the successful subscription, receiving a notification indicating the availability of the network energy related information associated with the at least one network element; and
upon receiving the notification indicating the availability of the network energy related information, obtaining the network energy related information from the OAM node using at least one of a streaming method and a File Transfer Protocol (FTP).

3. The method as claimed in claim 1, wherein the request further comprises a type of the network energy related information being requested and a periodicity of transmitting the network energy related information to the application function, wherein the type of the requested network energy related information comprises one or more of:
renewal energy consumption information associated with the at least one network element, total energy consumption information associated with the at least one network element, and energy efficiency information associated with the at least one network element.

4. The method as claimed in claim 1, wherein the at least one network element comprises a network slice for which the application function requests the network energy related information, and wherein the information identifying the at least one network element comprises Single-Network Slice Selection Assistance Information (S-NSSAI) associated with the network slice, and wherein the method comprises:
obtaining, from the OAM node, network energy related information associated with the network slice identified by the S-NSSAI and transmitting the obtained network energy related information associated with the network slice to the application function.

5. The method as claimed in claim 4, wherein the request further comprises information identifying one or more network functions (NFs) associated with the network slice identified by the S-NSSAI, and wherein the method comprises:
obtaining, from the OAM node, network energy related information associated with the one or more NFs and transmitting the obtained network energy related information associated with the one or more NFs to the application function.

6. The method as claimed in claim 1, wherein the request further comprises a time duration of which the network energy related information is requested, and wherein the method comprises:
obtaining, from the OAM node, the network energy related information associated with the at least one network element for the time duration specified in the request and transmitting the obtained network energy related information to the application function.

7. The method as claimed in claim 1, wherein receiving the request for the network energy related information from the application function comprises:
directly receiving the request for the network energy related information from the application function, when the application function is a trusted application function; and
receiving the request for the network energy related information from the application function via a Network Exposure Function (NEF), when the application function is an untrusted application function.

8. The method as claimed in claim 1, wherein transmitting the obtained network energy related information associated with the at least one network element to the application function comprises:
directly transmitting the obtained network energy related information associated with the at least one network element to the application function, when the application function is a trusted application function; and
transmitting the obtained network energy related information associated with the at least one network element to the application function via a Network Exposure Function (NEF), when the application function is an untrusted application function.

9. An apparatus configured to:
receive, from an application function, a request for network energy related information associated with at least one network element, wherein the request comprises information identifying the at least one network element;
based at least on the information identifying the at least one network element, obtain, from an Operations, Administration and Maintenance (OAM) node, the network energy related information associated with the at least one network element; and
transmit the obtained network energy related information associated with the at least one network element to the application function.

10. The apparatus as claimed in claim 9, wherein to obtain the network energy related information associated with the at least one network element, the apparatus is configured to:
transmit a subscription request to the OAM node, requesting the OAM node to notify regarding availability of the network energy related information associated with the at least one network element, wherein the subscription request comprises the information identifying the at least one network element;
in response to the subscription request, receive a subscription response from the OAM node indicating successful or unsuccessful subscription for notifying regarding the availability of the network energy related information;
in response to the successful subscription, receive a notification indicating the availability of the network energy related information associated with the at least one network element; and
upon receiving the notification indicating the availability of the network energy related information, obtain the network energy related information from the OAM node using at least one of a streaming method and a File Transfer Protocol (FTP).

11. The apparatus as claimed in claim 9, wherein the request further comprises a type of the network energy related information being requested and a periodicity of transmitting the network energy related information to the application function, wherein the type of the requested network energy related information comprises one or more of:
renewal energy consumption information associated with the at least one network element, total energy consumption information associated with the at least one network element, and energy efficiency information associated with the at least one network element.

12. The apparatus as claimed in claim 9, wherein the at least one network element comprises a network slice for which the application function requests the network energy related information, and wherein the information identifying the at least one network element comprises Single-Network Slice Selection Assistance Information (S-NSSAI) associated with the network slice, and wherein the apparatus is configured to:
obtain, from the OAM node, network energy related information associated with the network slice identified by the S-NSSAI and transmitting the obtained network energy related information associated with the network slice to the application function.

13. The apparatus as claimed in claim 12, wherein the request further comprises information identifying one or more network functions (NFs) associated with the network slice identified by the S-NSSAI, and wherein the apparatus is configured to:
obtain, from the OAM node, network energy related information associated with the one or more NFs and transmit the obtained network energy related information associated with the one or more NFs to the application function.

14. The apparatus as claimed in claim 9, wherein the request further comprises a time duration of which the network energy related information is requested, and wherein the apparatus is configured to:
obtain, from the OAM node, the network energy related information associated with the at least one network element for the time duration specified in the request and transmitting the obtained network energy related information to the application function.

15. The apparatus as claimed in claim 9, wherein to receive the request for the network energy related information from the application function, the apparatus is configured to:
directly receive the request for the network energy related information from the application function, when the application function is a trusted application function; and
receive the request for the network energy related information from the application function via a Network Exposure Function (NEF), when the application function is an untrusted application function.

16. The apparatus as claimed in claim 9, wherein to transmit the obtained network energy related information associated with the at least one network element to the application function, the apparatus is configured to:
directly transmit the obtained network energy related information associated with the at least one network element to the application function, when the application function is a trusted application function; and
transmit the obtained network energy related information associated with the at least one network element to the application function via a Network Exposure Function (NEF), when the application function is an untrusted application function.

17. A non-transitory computer readable media storing one or more computer executable instructions which, when executed by an apparatus, cause the apparatus to:
receive, from an application function, a request for network energy related information associated with at least one network element, wherein the request comprises information identifying the at least one network element;
based at least on the information identifying the at least one network element, obtain, from an Operations, Administration and Maintenance (OAM) node, the network energy related information associated with the at least one network element; and
transmit the obtained network energy related information associated with the at least one network element to the application function.

18. The non-transitory computer readable media as claimed in claim 17, wherein to obtain the network energy related information associated with the at least one network element, the one or more instructions cause the apparatus to:
transmit a subscription request to the OAM node, requesting the OAM node to notify regarding availability of the network energy related information associated with the at least one network element, wherein the subscription request comprises the information identifying the at least one network element;
in response to the subscription request, receive a subscription response from the OAM node indicating successful or unsuccessful subscription for notifying regarding the availability of the network energy related information;
in response to the successful subscription, receive a notification indicating the availability of the network energy related information associated with the at least one network element; and
upon receiving the notification indicating the availability of the network energy related information, obtain the network energy related information from the OAM node using at least one of a streaming method and a File Transfer Protocol (FTP).

19. The non-transitory computer readable media as claimed in claim 17, wherein the request further comprises a type of the network energy related information being requested and a periodicity of transmitting the network energy related information to the application function, wherein the type of the requested network energy related information comprises one or more of:
renewal energy consumption information associated with the at least one network element, total energy consumption information associated with the at least one network element, and energy efficiency information associated with the at least one network element.

20. The non-transitory computer readable media as claimed in claim 17, wherein the at least one network element comprises a network slice for which the application function requests the network energy related information, and wherein the information identifying the at least one network element comprises Single-Network Slice Selection Assistance Information (S-NSSAI) associated with the network slice, and wherein the one or more instructions further cause the apparatus to:
obtain, from the OAM node, network energy related information associated with the network slice identified by the S-NSSAI and transmitting the obtained network energy related information associated with the network slice to the application function.
